(19) United States
(12) Patent Application Publication
(10) Pub. No.: US 2009/0260049 A1
(43) Pub. Date: Oct. 15, 2009

(54) Automatic drop/house return termination system

(76) Inventor: Tibor Urbanek, Britton, MI (US)

Correspondence Address: Karl D. Kovach, Esq.;Emerson Network Power Connectivity Solutions, Inc., Suite 308N, 3000 Lakeside Drive, Bannockburn, IL, 60015, US

(21) Appl. No.: 12/384,808

(22) Filed: Apr. 9, 2009

Related U.S. Application Data
(60) Provisional application No. 61/124,062, filed on Apr. 14, 2008.

(51) Int. Cl. H04N 7/173

(52) U.S. Cl. 725/125

(57) ABSTRACT

The device provides for a detector and switch which allows a signal to be transmitted from the subscriber to the head-end provider, but, in all other circumstances, the device does not allow other signals or ingress to enter the CATV system from the subscriber's house.

This non-provisional application claims the priority of earlier filed U.S. Provisional Application Ser. No. 61/124,062, filed Apr. 14, 2008. U.S. Provisional Patent Application Ser. No. 61/124,062 is hereby incorporated herein by reference.

### BACKGROUND OF THE INVENTION

1. Field of the Invention

The present invention pertains to cable television (CATV) systems. The invention more particularly concerns a CATV system where distortion or ingress of the return band is reduced so as to make the return band more distortion free and thus usable.

2. Discussion of the Background

The return band of most CATV systems is in the range of 5 MHz to 42 MHz. The return band is the frequency range by which houses or subscribers send information or a signal to the distributor of the CATV system, otherwise known as the head-end provider. Sources of ingress include the subscriber's house, and the drop. Ingress typically occurs in the frequency range of 5 MHz to 15 MHz. Thus the return band is practically un-usable in the frequency range of 5 MHz to 10 MHz. The return band is partially usable in the frequency range of 10 MHz to 15 MHz by robust carriers using frequency shift keying (FSK) or quadrature phase shift keying (QPSK) modulation which is used for status monitoring devices. However, some nodes may experience distortion up to 20 MHz. FIG. 1 is a three dimensional graph of ingress recorded at the head-end on a typical node. The ingress is measured in terms of relative amplitude in decibels (dB) which is the signal level in dB relative to the highest desired signal level. The second dimension in the graph of FIG. 1 is the dimension of frequency which is shown in megahertz (MHz). The third dimension in the graph of FIG. 1 is the dimension of time which is shown as the time of day in an hour:minute format based on a day consisting of twenty-four hours. FIG. 1 graphically represents the ingress of the return band between 5 MHz and 15 MHz and especially between 5 MHz and 10 MHz. FIG. 1 further graphically represents the desired return band signal which is approximately in the range of 20 MHz to 30 MHz.

Other sources of ingress are minimized in the remainder of the CATV system since the fiber distribution network utilizes higher quality cables and equipment having better shielding. Additionally, such cable and equipment are typically installed further away from sources of interference such as power lines and appliances.

### SUMMARY OF THE INVENTION

The invention provides for a CATV system where the return band can be turned off when the subscriber does not provide a signal to the head-end provider, and the return band can be turned on when the subscriber does provide a signal to the head-end provider. Thus, the invention provides for more efficient use of the return band of the CATV system, and the invention makes better use of the equipment and cables which are currently deployed in CATV systems.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a three dimensional graphical representation of ingress verses frequency and time for a current prior art CATV system; and

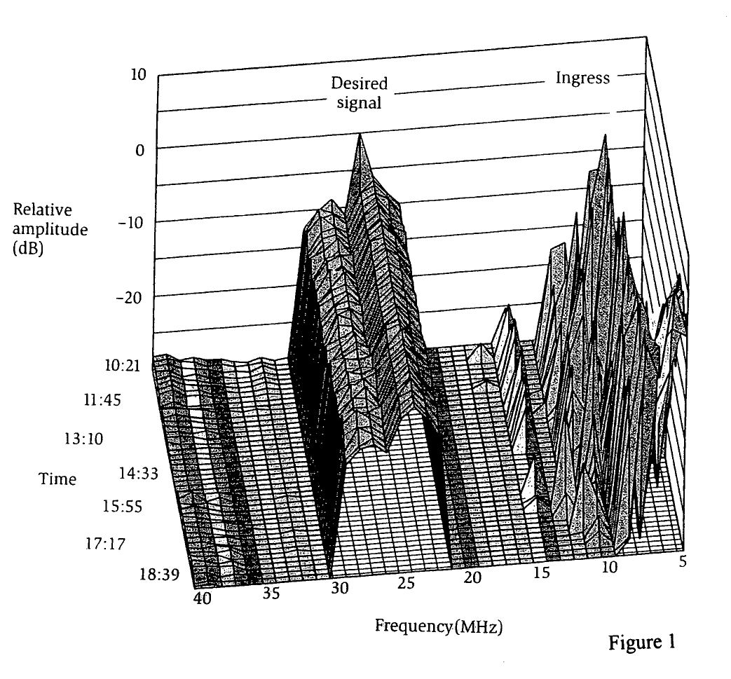

FIG. 2 is a schematic or block diagram of a CATV system which utilizes the invention.

### DETAILED DESCRIPTION OF THE PRESENTLY PREFERRED EMBODIMENT

Referring now to the drawings, wherein like reference numerals designate identical or corresponding parts through the several views, an embodiment of the present invention is displayed therein.

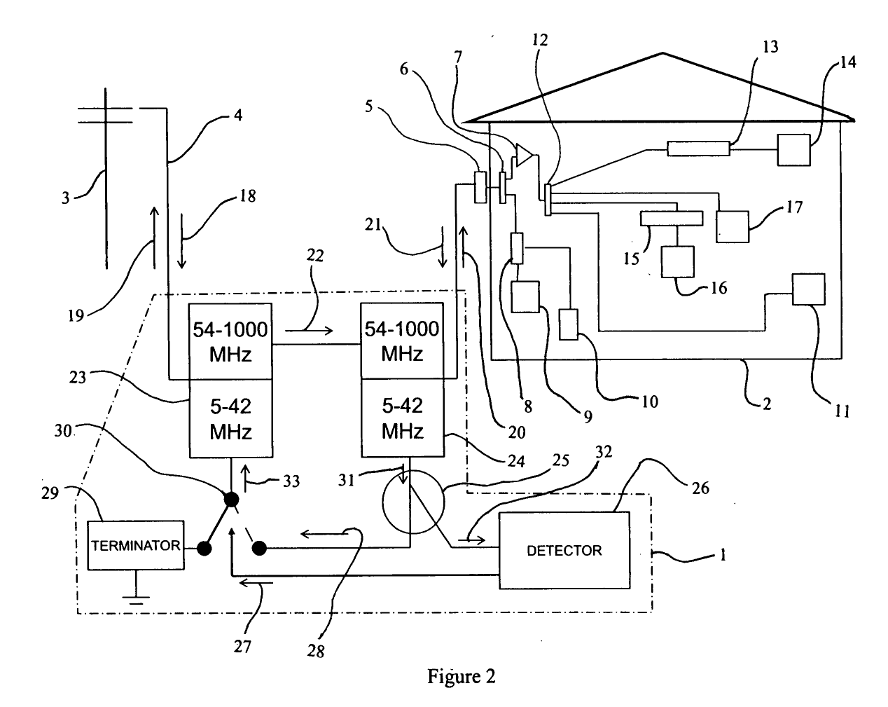

FIG. 2 is a schematic or block diagram of the current invention or device 1. As used in the field, the device 1 is placed between the house 2, which is the subscriber, and the head-end provider which is attached to the device 1 via CATV networking lines 4 which can be attached to a pole 3.

Attached to the house 2 is shown a cable TV main input 5. Inside the house 2 is shown a splitter 6 the output of which feeds into a house amplifier 7 and a modem 8. The output of the modem 8 feeds into a computer 9 and a telephone 10. The output of the house amplifier 7 feeds into a second splitter 12. The output of the second splitter 12 feeds into a set-top box 13, a second set-top box 15, an analog TV 17, and a second analog TV 11. The output of the set-top box 13 feeds into a TV set/monitor 14. The output of the second set-top box 15 feeds into a TV set/monitor 16. The equipment electrically connected to the CATV network inside the house are shown by way of example. More or less equipment may be used as set by the preference of the user.

The device 1 includes a first diplex filter 23, a second diplex filter 24, a directional coupler 25, a detector 26, a terminator 29, and a switch 30. The first diplex filter 23 is electrically connected to the second diplex filter 24, the CATV networking lines 4, and a switch 30. The second diplex filter 24 is electrically connected to the first diplex filter 23, the cable TV main input 5 and to the directional coupler 25. The output of the directional coupler 25 is electrically connected to the detector 26 and the second output of the directional coupler 25 is electrically associated with the through state position of the switch 30. The output of the detector 26 is electrically associated with the switch 30. The device 1, as shown in FIG. 2, is in the terminated state and has the conductive arm of the switch 30 in electrical association with the terminator 29. The output of the switch 30 is electrically associated with the first diplex filter 23. The first and second diplex filters 23, 24 filter out all other frequencies which are not in the frequency ranges 5 MHz to 42 MHz and 54 MHz to 1000 MHz.

When a signal, the direction of which is indicated by arrow 18, flows from the head-end provider it enters the first diplex filer 23. The first diplex filter 23 allows signals, the direction of which is indicated by arrow 22, in the frequency range of 54 MHz to 1000 MHz to pass through and to the enter the second diplex filter 24. The second diplex filter 24 allows signals, the direction of which is indicated by arrow 20, from the head-end provider in the frequency range of 54 MHz to 1000 MHz to pass through and to enter the cable TV main input 5 for distribution throughout the house 2.

When the subscriber in the house 2 sends a signal to the head-end provider, the signal exits the house 2 via the cable TV main input 5 follows a path in a direction shown by the arrow 21. The signal enters the second diplex filter 24. Provided the signal from the subscriber is in the range of 5 MHz to 42 MHz, the second diplex filter 24 allows the signal, the direction of which is indicated by arrow 31, to pass through and onto the directional coupler 25. The directional coupler 25 taps off a small portion of the signal, the direction of which is indicated by arrow 32, from the subscriber and passes it onto the detector. The remainder of the signal, the direction of which is indicated by arrow 28, from the subscriber is directed to the lead of the switch 30 associated with the through state. The detector 26 detects the presence of the signal from the subscriber and the detector 26 then sends a trigger signal, the direction of which is indicated by arrow 27, to the switch 30 so as to change the state of the switch 30 from the terminated state, as shown in FIG. 2, to the through state. Once the switch 30 is in the through state, the signal, the direction of which is indicated by arrow 33, from the subscriber enters the first diplex filter 23. The first diplex filter 23 allows the subscriber signal, the direction of which is indicated by arrow 19, to pass through and onto the cable TV networking lines 4 and onto the head-end provider, provided the signal form the subscriber is in the range of 5 MHZ to 42 MHz. Once the subscriber stops sending a signal to the head-end provider, the detector 25 stops receiving a signal 32 and the detector 25 then stops sending to the switch 30 the trigger signal 27, and thus the switch 30 is then switched from the through state to the terminated state. The terminated state is shown in FIG. 2. Thus the device 1 terminates or turns off the return band, which is in the frequency range of between 5 MHz to 42 MHz, emanating from the subscriber 2. Thus, ingress due to the subscriber 2 being connected to the CATV coaxial distribution system 4 is reduced. Once the subscriber 2 sends as signal to the head-end provider, the detector 26 detects the signal and allows the signal to proceed to the head-end provider, thus turning on the return band. When the detector 26 detects the activity, the detector activates a very fast switch 30 which switches from the terminated state to the through state.

The detector 26 and terminator 29 can be placed on the outside of the subscriber's house 2 to eliminate house ingress or it can be installed on the outdoor directional coupler 25 in which case both the house ingress and the drop ingress would be eliminated.

Assuming an average node size of five hundred homes and eighty percent penetration of CATV services, there is probably sixty percent penetration of the two-way services, which means that there is a possibility of three hundred customers' returns continuously contributing to ingress in the return band. Another one-hundred-twenty homes which do not have two-way service, but only get analog TV, are probably also contributing to the ingress if a standard 54 MHz to 1000 MHz high pass filter was not installed in each of the homes. Assuming that at any given time only five percent of the two-way devices are transmitting on the return band or frequency, the device of the invention would eliminate ingress of two-hundred-eighty-five drops and houses of two-way subscribers and the transmitting devices at any given time would be affected by ingress from fifteen drops and houses and not three hundred drops and houses.

The device 1 cleans the lower end of the return band in the frequency range of 9 MHz to 15 MHz. The frequency range of 9 MHz to 15 MHz can then be used for possible 64-state quadrature amplitude modulation (64 QAM) upstream data transmission, thus adding an additional 30 Mb/s, using data over cable service interface specification version 3.0 (DOCSIS 3.0) upstream channel bonding feature. In such a scenario, the upstream band data transfer rate could be increased from currently practically achievable 105 Mb/s to 150 Mb/s. If the entire bandwidth could be cleared down to 5 MHz, then the entire upstream channel bonded data transmission speed could be increased up to 165 Mb/s.

Obviously, numerous modifications and variations of the present invention are possible in light of the above teachings. It is therefore to be understood that within the scope of appended claims, the invention may be practiced otherwise than as specifically described herein.

1. A device for detecting a signal from a subscriber and for allowing the signal to continue to a head-end provider so as to reduce ingress into a CATV system, the device comprising:
a detector for detecting the signal from the subscriber; and
a switch for allowing the signal from the subscriber to continue to the head-end provider, and when the subscriber does not send a signal to the head-end provider all other signals emanating from the subscriber's house are not allowed to proceed to the head-end provider.

2. A device according to claim 1, further comprising a directional coupler electrically associated with the detector.

3. A device according to claim 2, further comprising a first diplex filter electrically associated with the switch.

4. A device according to claim 3, further comprising a second diplex filter electrically associated with the first diplex filter and the directional coupler.

5. A device according to claim 4, further comprising a terminator, and wherein, when the device is in a terminated state, the terminator is electrically associated with the switch which is when the subscriber does not send a signal to the head-end provider.

6. A device according to claim 5 wherein, when the device is in a through state, the subscriber sends a signal to the head-end provider, the second diplex filter passes the signal to the directional coupler, the directional coupler send a small portion of the signal to the detector, the detector sends a trigger signal to the switch, the switch switches from being connected to the terminator so as to be electrically connected to the directional coupler, the directional coupler passes a majority of the signal to the switch, the switch passes the signal to the first diplex filter, and the first diplex filter passes the signal to cable TV networking lines for delivery to the head-end provider.

7. A device according to claim 6 wherein the first diplex filter operates in frequency ranges between 54 MHz to 1000 MHz and 5 MHZ to 42 MHz.

8. A device according to claim 7 wherein the second diplex filter operates in the frequency ranges between 54 MHz to 1000 MHZ and 5 MHz to 42 MHz.

9. A device according to claim 8 wherein the signal from the subscriber is in a frequency range of 5 MHz and 42 MHz.

10. A device according to claim 9 wherein a signal from the head-end provider is in the frequency range of 54 MHz to 1000 Mhz.

11. A device comprising:
a directional coupler;
a detector electrically associated with the directional coupler; and
a switch electrically associated with the detector.

12. A device according to claim 11, further comprising a first diplex filter electrically associated with the switch.

13. A device according to claim 12, further comprising a second diplex filter electrically associated with the first diplex filter and the directional coupler.

14. A device according to claim 13, further comprising a terminator, and wherein, in a terminated state, the switch is electrically associated with the terminator and not the directional coupler, and wherein, in a through state, the switch is electrically associated with the directional coupler and not the terminator.

15. A device according to claim 14 wherein the first diplex filter operates in frequency ranges between 54 MHz to 1000 MHz and 5 MHZ to 42 MHz.

16. A device according to claim 15 wherein the second diplex filter operates in the frequency ranges between 54 MHz to 1000 MHZ and 5 MHz to 42 MHz.

17. A device interposed between a CATV networking line and a subscriber's house, the device comprising:
a first diplex filter electrically associated with the CATV networking line;
a second diplex filter electrically associated with the first diplex filter and the subscriber's house;
a directional coupler electrically associated with the second diplex filter;
a detector electrically associated with the directional coupler;
a switch electrically associated with the detector; and
a terminator, and wherein,
in a terminated state, the switch is electrically associated with the terminator and not the directional coupler, and wherein,
in a through state, the switch is electrically associated with the directional coupler and not the terminator.

18. A device according to claim 17 wherein the first diplex filter operates in frequency ranges between 54 MHz to 1000 MHz and 5 MHZ to 42 MHz.

19. A device according to claim 18 wherein the second diplex filter operates in the frequency ranges between 54 MHz to 1000 MHZ and 5 MHz to 42 MHz.

20. A device according to claim 19 wherein a return signal from the subscriber's house is in a frequency range of 5 MHz and 42 MHz.
